(19) United States
(12) Patent Application Publication
(10) Pub. No.: US 2015/0294071 A1
(43) Pub. Date: Oct. 15, 2015

(54) METHOD AND COMPUTER PROGRAM FOR RESOURCE SCHEDULING

(71) Applicant: AGFA HEALTHCARE, Mortsel (BE)

(72) Inventor: Geert Machtelinck, Mortsel (BE)

(21) Appl. No.: 14/435,286

(22) PCT Filed: Nov. 5, 2013
(86) PCT No.: PCT/EP2013/072997

§ 371 Date: Apr. 13, 2015

Related U.S. Application Data
(60) Provisional application No. 61/729,638, filed on Nov. 26, 2012.

(30) Foreign Application Priority Data
Nov. 23, 2012 (EP) 12193955.7

(51) Int. Cl. G06F 19/00

(52) U.S. Cl. CPC G06F 19/327

(57) ABSTRACT

A method of operating a data processing system for resource scheduling in which, for large scale scheduling tasks, the data processing system is operated according to a first method of operation including the steps of calculating an initial solution space including at least one valid scheduling solution, and displaying the at least one valid scheduling solution.

### CROSS-REFERENCE TO RELATED APPLICATIONS

This application is a 371 National Stage Application of PCT/EP2013/072997, filed Nov. 5, 2013. This application claims the benefit of U.S. Provisional Application No. 61/729,638, filed Nov. 26, 2012, which is incorporated by reference herein in its entirety. In addition, this application claims the benefit of European Application No. 12193955.7, filed Nov. 23, 2012, which is incorporated by reference herein in its entirety.

### BACKGROUND OF THE INVENTION

1. Field of the Invention

The present invention generally relates to a method and system for the resource scheduling, more specifically for automated scheduling of resources such as patients, medical personnel, medical equipment and medical facilities in a medical institution taking into account operational constraints.

2. Description of the Related Art

A system for resource scheduling is for example known from WO 2006/094890. It concerns a system for resource scheduling in a medical context that is advantageously able to provide a plurality of valid scheduling solutions instead of only a single valid scheduling solution. When such a resource scheduling system needs to calculate a solution space for a large scale scheduling task involving a large number of resources and/or applying to a large time period to be covered, such as for example is the case in a large scale medical institution handling a large number of patients, personnel, treatment plans, image acquisition devices, hospital rooms, etc., this solution space could result in response times of the scheduling system to rise above acceptable limits of for example a few seconds.

Thus there still exists a need for more efficient resource scheduling system that is able to flexibly provide the user with a plurality of valid scheduling solutions and overcomes the technical problem of requiring excessive computational power to do so.

### SUMMARY OF THE INVENTION

According to a first aspect of the invention there is provided a data processing system for resource scheduling taking into account the availability of a set of resources, said data processing system configured to:
calculate an initial solution space comprising at least one valid scheduling solution and display said at least one valid scheduling solution, when said total solution space is larger than a predetermined total solution space threshold, and
calculate a total solution space comprising all valid scheduling solutions and display said at least one of said plurality of said valid scheduling solutions, when said total solution space is smaller than said predetermined total solution space threshold.

This allows to provide the user with a valid solution within the limits for an acceptable response time of the resource scheduling system, even when the calculation of the total solution space would exceed these acceptable limits. This is done without consuming large amounts of additional computing power and without compromising the quality and flexibility of valid scheduling solutions provided in simple cases for which the total solution space can be calculated within acceptable limits for the response time. It is thus clear that this data processing system allows for the technical effect of shorter computing times and less storage space as not all valid scheduling solutions must be calculated for large solution spaces. This makes it possible to perform resource scheduling on small computer systems which were previously not powerful enough for the purpose, or to calculate and display valid scheduling solutions for total solution spaces that could not be processed on any available computer system. Such computational resource efficiency thus constitutes a technical effect which goes beyond the normal physical interaction between a computer program and a data processing system. The data processing system must be considered technical per se. It is further clear that this data processing system, is provided with functional features, which configure it to perform calculations that cannot be performed by purely mental or mathematical means, and thus must be taken into account as features contributing technical character.

According to a preferred embodiment said data processing system is further configured to:
calculate an additional solution space comprising at least one additional valid scheduling solution, when the number of said valid scheduling solutions is smaller than a predetermined additional solution threshold, and display said at least one additional valid scheduling solution, when said total solution space is larger than said predetermined total solution space threshold.

In this way the system provides the user with a valid scheduling solution within an acceptable response time and during review of this valid scheduling solution the system is able to calculate further alternative solutions in the background augmenting flexibility for the user.

According to a further preferred embodiment said data processing system is configured to calculate said initial solution space and/or said additional solution space as a subset of said total solution space, said subset being selected in function of a predetermined set of selection parameters.

According to still a further preferred embodiment that said selection parameters comprise one or more of the following:
a lead time, which is the time period from now up till the initiation of said valid scheduling solution;
a resource count, which is the number of different resources involved in said valid scheduling solution;
a schedule duration, which is the time period between the initiation and the end of said valid scheduling solution;
a cost level, which is a function of the cost of the resources of a valid scheduling solution;
a resource priority, which is a preference parameter associated with a specific resource of a valid scheduling solution;
a resource compatibility level, which is a preference parameter associated with a specific combination of resources of a valid scheduling solution;
a fragmentation level, which is the level of fragmentation in the schedule of the resources of a valid scheduling solution;
a location count, which is the number of different locations associated with the resources of a valid scheduling solution.

Preferably the data processing system is further configured to calculate for each of said valid scheduling solutions a corresponding quality parameter in function of said selection parameters; and display only said additional valid scheduling solution for which said corresponding quality parameter exceeds said corresponding quality parameter of the already displayed valid scheduling solutions, when said total solution space is larger than said predetermined total solution space threshold.

According to a preferred embodiment the data processing system is further configured to calculate said quality parameter such that its value is maximized when the values of said selection parameters are minimized.

These preferred embodiments allow to optimize and automate to varying degrees the efficient selection of the initial solution space in order to provide as fast as possible valid scheduling solution alternatives that are closely related to an optimal scheduling solution.

Optionally the data processing system is further configured to calculate said additional solution threshold in function of the number of additional valid scheduling solutions, that are provided by said additional solution space, which have a corresponding quality parameter that exceeds said corresponding quality parameter of the already displayed valid scheduling solutions.

In this way the user is only signalled alternative solutions that were not yet displayed if they provide a higher quality option.

According to still a further preferred embodiment the data processing system is further configured to calculate said initial solution space by decomposing said resource scheduling into a plurality of Simple Temporal Problems.

Preferably the data processing system is further configured to calculate said initial solution space from said plurality of Simple Temporal Problems by means of operations on Simple Temporal Problem matrices representing said Simple Temporal Problems.

According to still a further preferable preferred embodiment the data processing system is further configured to perform said operations on said Simple Temporal Problem matrices by means of continuations, said continuations being configured to:
calculate partial results from specific operations on specific Simple Temporal Problem matrices when said partial result of this operation is necessary for the calculation of a valid scheduling solution; and
cache said partial results so that said calculation of said specific operation on said specific Simple Temporal Problem matrices has to be performed only once.

This allows to optimize the calculation of a large number of valid scheduling solutions associated with a large scale solution space and allows these calculations to be performed in parallel on a plurality of processors or processor cores in order to still further improve responsiveness. This implementation outperforms recursive implementations known from the prior art.

According to still a further preferred embodiment said data processing system is further configured to calculate said initial solution space by means of genetic algorithms.

This allows to automate the search for an optimal configuration of the method according to a preferred embodiment of the invention by automatically adjusting its threshold on the basis of the performance of the system resulting from processing a plurality of scheduling scenarios.

According to a second aspect of the invention there is provided a method of operating the data processing system of the first aspect of the invention.

According to a third aspect of the invention there is provided a computer program comprising software code adapted to perform the method according to the second aspect of the invention when executed by a computer.

According to a fourth aspect of the invention there is provided a computer readable storage medium comprising the computer program according to the third aspect of the invention.

### BRIEF DESCRIPTION OF THE DRAWINGS

FIG. 1 schematically illustrates a preferred embodiment of the method according to the invention.

FIG. 2 schematically illustrates the components of a preferred embodiment of the data processing system 1 for performing the method of FIG. 1.

FIG. 3 schematically illustrates a preferred embodiment of a graphical user interface.

FIG. 4 schematically illustrates a suitable computing system for operating according to the method of FIG. 1.

### DETAILED DESCRIPTION OF THE PREFERRED EMBODIMENTS

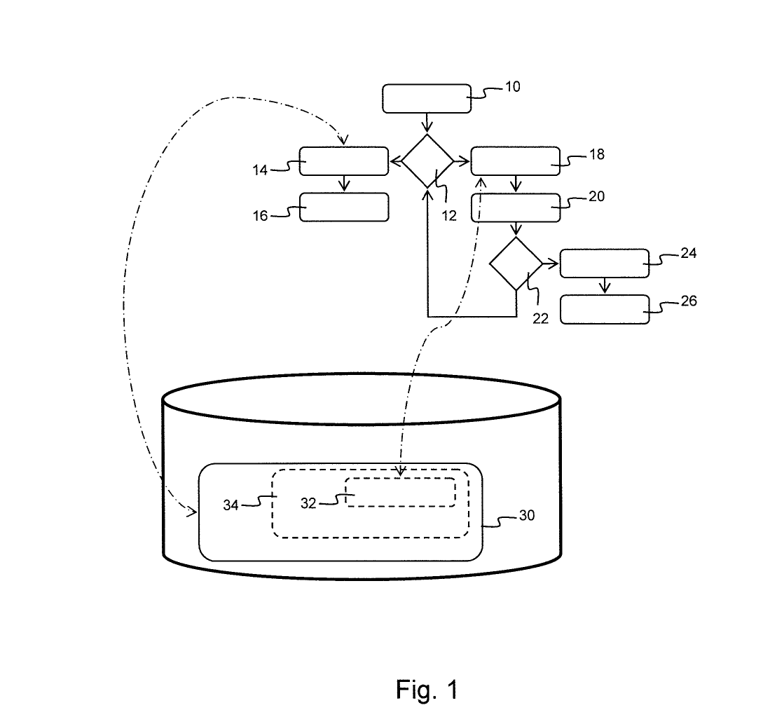

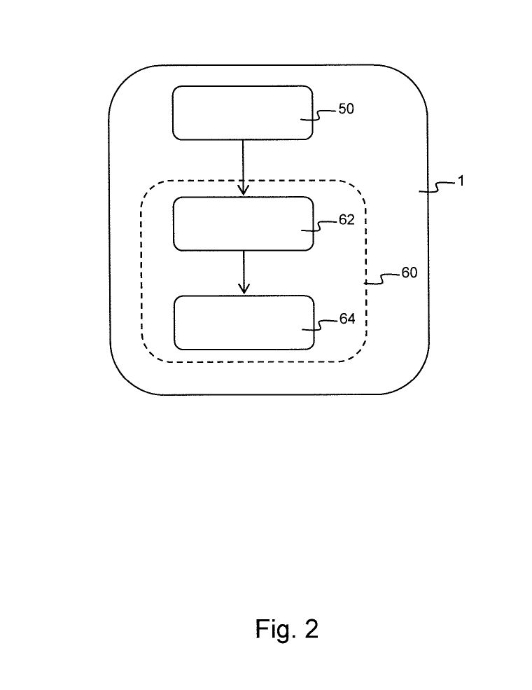

FIG. 1 shows schematically the method of operation of a data processing system 1 for scheduling resources of which a preferred embodiment is shown in FIG. 2. Such a system is for example implemented as a software application comprising suitable programming instructions for execution by a processor of a computing system. Alternatively it could form a component of a software application, for example in the form of an application module, by means of a programming library, as s network component being accessible through a suitable application program interface, or any other suitable implementation. The system 1 is especially beneficial when being part of a system that automatically generates a large number of schedules for a large number of resources. This is for example the case in the context of a resource scheduling system in a medical imaging environment, such software application is for instance important in medical imaging applications such as radiology, where a nurse needs to suitably prepare the patient for the imaging operation by providing and recording information to and from the patient, a technician acquires medical images of a patient (e.g. an x-ray scan, a CT scan, an MRI scan, an ultrasound scan, etc.) and post-processes these images in order to enable specific forms of analysis, a radiologist interprets the medical images, a transcriptionist produces a report reflecting the radiologists' interpretation, and a clinician receives the report and advises the patient. The individuals and other resources involved in the entire workflow may be working at a single facility (e.g. a hospital or imaging centre) or may be working at different locations (e.g. a hospital or enterprise with multiple facilities). In order to enable an efficient use of such medical image acquisition devices and coordinate in a timely way all related resources linked to it, a resource scheduling system will be deployed and made accessible to the involved actors.

The preferred embodiment of the data processing system 1 for resource scheduling as shown in FIG. 2 comprises is structured in a plurality of modules. The highest level module concerns the medical domain module 50. This medical domain module 50 links the general concepts such as resources and activities to specific concepts in the medical domain such as appointments, procedures, doctors, medical equipment, etc. This medical domain module 50 can be linked to a suitable graphical user interface to allow interaction with a user and suitable storage structures such as for example a database for retrieval and storage of relevant data. This medical domain module 50 is able to present real-world schedules for activities of a set of resources such as people, rooms, equipment in function of their constraints such as their availabilities and competences. Preferably it can automatically retrieve details of predetermined procedures and task definitions, their prerequisites and relations. Preferably it also allows to configure predetermined quality criteria that are specifically relevant in the hospital, this means such a configuration can allow to formalise what kind of scheduling solutions are preferred over others. The medical domain module 50 also provides access to an up to date set of data that provides all constraints involved during calculation of valid scheduling solutions, such as for example temporal constraints and suitability of all resources available to the hospital.

When a resource scheduling request is initiated at step 10 of the method as shown in FIG. 1 the medical domain module 50 will translate this request to the more general concepts that are processed by the Generic Temporal Engine 60 which will calculate a valid scheduling solution taking into account the availability of the specific set of resources as provided by the medical domain module 50. The generic temporal engine 60 of the preferred embodiment shown in FIG. 2 comprises two main components namely activity calculator 62 and the domain calculator 64. The activity calculator 62 provides the basic functionality for calculating a valid scheduling solution for a set of resources by providing a solution space. Such a solution space is a representation of one or more valid solutions for a scheduling request. Such a scheduling request will be decomposed by the Generic Temporal Engine in one or more activities for the set of resources that fulfil the requirements of a predetermined constraints linked to those resources. The valid scheduling solutions of the solution space may be filtered or ranked by means of predetermined quality parameters.

At the next step 12 of the preferred embodiment of the method shown in FIG. 1 the data processing system 1 by means of the activity calculator 62 will compare the size of a total solution space 30, which comprises all valid scheduling solutions for the scheduling request of step 10, with a predetermined total solution space threshold. This predetermined total solution space threshold is a parameter that can be configured in function of the desired responsiveness of the data processing system 1, such as for example the maximum time delay that is allowed between a scheduling request and providing a valid scheduling solution to the user. The size of the total solution space 30 can easily be estimated in function of for example the number of specific resources in the set of resources and their related constraints to be considered, the number of different activities in the scheduling request to be considered, etc. When the total solution space 30 is larger than the predetermined total solution space threshold the data processing system 1 will be operated according to a first method of operation by proceeding to step 18. When the total solution space 30 is smaller than the predetermined total solution space threshold the data processing system 1 will be operated according to a second method of operation by proceeding to step 12 at which the total solution space comprising all valid scheduling solutions will be calculated and subsequently to step 14 where at least one of these valid scheduling solutions is displayed for selection by the user. In this way the system is able to provide the most comprehensive set of valid scheduling solutions to the user for scheduling requests that can be easily processed within acceptable time limits.

According to the first method of operation however, instead of calculating the total solution space 30, which for these larger scheduling requests would lead to unacceptable delays, at step 18 an initial solution space 32 is calculated. This initial solution space 32 is a smaller subset of the total solution space 30 and its only requirement is that it must be able to provide at least one valid scheduling solution for the scheduling request at hand. As soon as this valid scheduling solution is calculated from this initial solution space 32 it will be displayed to the user of the system at step 20 thus enabling the required responsiveness even for these large scheduling requests. The initial solution space 32 can be calculated by making use of Temporal Reasoning techniques. According to such a preferred embodiment the activity calculator 62 will decompose the one or more activities of the resource scheduling request into a plurality of Simple Temporal Problems. The Simple Temporal Problems can be represented by means of Simple Temporal Problem matrices from which the initial solution space 32 can be calculated as operations on these Simple Temporal Problem matrices are able to provide reduced solution spaces for which it is certain that a valid scheduling solution exists. In order to still further optimise this process, according to the preferred embodiment shown in FIG. 2, the operations on said Simple Temporal Problem matrices are executed by a Domain calculator which implements them by means of continuations. This means that execution of partial results of these operations on the Simple Temporal Problem matrices is postponed until are necessary for the calculation of a valid scheduling solution and that these partial results are cached so that these calculations have to be performed only once.

As shown in FIG. 1, the first method of operation will subsequently proceed to step 22 where the number of valid scheduling solutions provided by the initial solution space 32 will be compared to a predetermined additional solution threshold. If this number is smaller than this threshold the an additional solution space 34 will be calculated comprising at least one additional valid scheduling solution at step 24 which will subsequently be displayed at step 26. So while the user is reviewing the initial results from the initial solution space 32, in the background additional results can be calculated and subsequently presented to the user in order to increase the number of available scheduling option to a desirable amount. This process can optionally be iteratively repeated a plurality of times until a sufficient number of results is provided with respect the additional solution threshold.

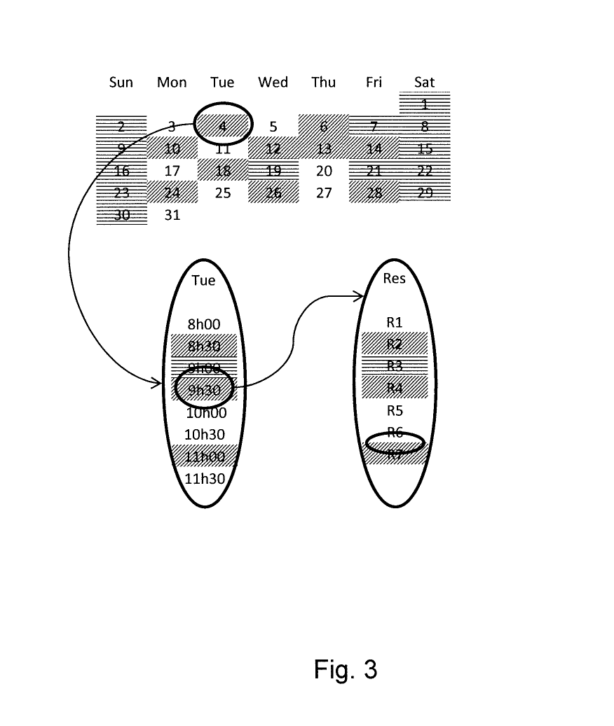

A suitable graphical user interface to support the efficient display of the valid scheduling solutions as available in the initial solution space 32 or additionally in an additional solution space 34 is schematically shown FIG. 3. It shows interactive components that support the user in easily making a selection of a plurality of alternatives of valid scheduling solutions. It shows first a daily overview of the days of a period covering one month. Days during which a valid starting moment is available for the scheduling request are marked with diagonal stripes. Days where no valid scheduling solution can be started are marked with horizontal stripes. Days which were not covered by the initial solution space 32 or an additional solution space 34 are shown are shown without stripes. When the user is selects a day for which a valid scheduling solution can be started, as shown, the user is presented with a list of time periods for which a valid scheduling solution can be started. Again diagonal stripes indicate a valid scheduling solution is available, vertical stripes indicates no valid scheduling solution is available and no stripes indicates the time period was not covered by the initial solution space 32 or the additional solution space 34. Subsequently when the user selects a time period for which a valid solution can be started, the user will be presented with a list of resources where again is indicated with the same stripe code for which resources a valid scheduling solution is available. It is clear that various alternative scenario's and visualisations are available, for example instead of the stripe code a colour code could be used, such as for example green for items where a valid scheduling solution is available, red for instances where no valid scheduling solution is available and grey for instances that were not part of the initial or additional solution space. Preferably each selection of a parameter by the user is saved, and triggers the calculation of an additional solution space taking into this specific limitations for calculating additional valid scheduling solutions during interaction of the user with the graphical user interface.

The activity calculator 32 preferably additionally makes use of a predetermined set of selection parameters in order to reduce the total solution space 30 to a suitable subset from which the initial solution space 32 or the additional solution space 34 can be calculated. Such selection parameters could for example comprise a lead time, a resource count, a schedule duration, etc. Such a lead time is the time period from now up till the initiation of said valid scheduling solution; the resource count is the number of different resources involved in said valid scheduling solution; and the schedule duration being the time period between the initiation and the end of said valid scheduling solution. The initial solution space 32 can then be calculated so that these particular selection parameters are minimized for the valid scheduling solutions it comprises, this means it will preferably provide scheduling solutions that can start as soon as possible, involve a minimum amount of different resources such as personnel and equipment and take a minimum amount of time from start to finish. It is clear that additionally the user, as explained above with reference to FIG. 3, during the scheduling operation can provide additional selection parameters which can be taken into account to make a suitable calculation of for example an additional solution space 34. Preferably these selection parameters are also used to calculate a corresponding quality parameter for the valid scheduling solutions. This enables the system to rank the alternative valid scheduling solutions to be displayed, but it can equally limit any unnecessary interference with the already displayed results. This can be implemented by for example displaying only the additional valid scheduling solutions provided by the additional solution space 34 for which the corresponding quality parameter exceeds that of the already displayed valid scheduling solutions. This means that, for the example described example above, only additional results will be provided if the selection parameters such as lead time, resource count or schedule duration are minimized with respect to already displayed results.

It is clear that according to alternative preferred embodiments other suitable selection parameters or combinations of selection parameters could be considered. One such example of such a selection parameter is a cost level, which means an estimation of the cost of a valid scheduling solution such that for example more cost-effective resources or resources which are more cost-effective during operation lead to a lower value for the cost parameter. Another example is fragmentation level, which means that solutions are preferred which make possible that the appointments in the schedules of individual resources are clustered in order to avoid too much space in between these appointments which causes fragmentation. Another example is resource priority, which means that to each resource a priority property is associated so that the selection of a specific resource from a plurality of suitable resources can be automatically determined. Still another example is Resource compatibility, which means that the system can be configured to prefer specific combinations of resources. A specific doctor could for example prefer a specific examination room even if there are other suitable examination rooms available, or this parameter could also be used to link together a group of people that form a team and prefer to cooperate. The system is in this way thus able to prefer valid scheduling solutions that provide the most compatible resources. Still another example for a selection parameter is location count, which means that the system will prefer solutions with resources that require a minimal amount of displacements.

This quality parameter also allows to adaptively adjust the threshold for providing additional valid scheduling solutions. The number of additional valid solutions provided by an additional solution space of which the quality parameter exceeds the corresponding quality parameter of the already displayed valid scheduling solutions is an indication for the likelihood that the globally optimal scheduling solution has been found. Certainty that this most optimal scheduling solution has been found can only be guaranteed when the total solution space has been completely calculated, however the percentage of additional solutions of higher quality than those already displayed can provide a measure for the likelihood that the alternatives close to the global optimal solution are among the options already displayed.

In order to optimize calculation of the initial solution space adaptively it is preferred to make use of genetic algorithms that will try a plurality of modifications on different configuration parameters and thresholds of the generic temporal engine 60 on a plurality of representative data sets and automatically evaluate the results in function of evaluation parameters such as for example the time required to process the entire solution space, the time required to calculate an initial solution space providing at least one valid scheduling solution and/or the time required to find the most optimal solution in function of the quality parameters. These genetic algorithms are able to make such adjustments even while the data processing system is in operation by processing real world or test case scheduling requests, for example during low load periods.

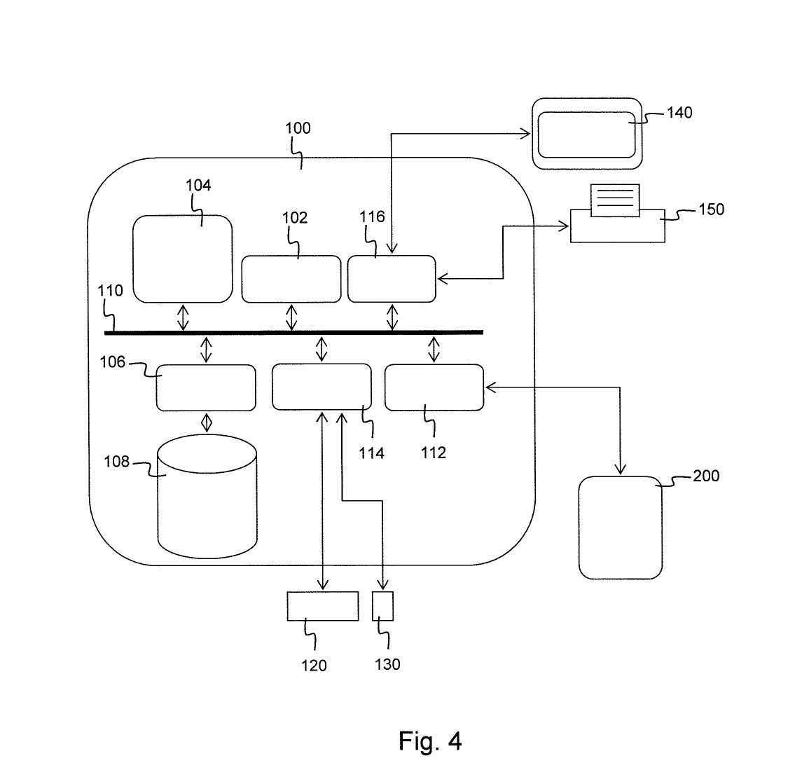

FIG. 4 shows a suitable computing system 100 for hosting data processing system 1 of FIGS. 1 and 2. Computing system 100 may in general be formed as a suitable general purpose computer, such as a workstation, a server, a laptop, a desktop, a hand-held device, a mobile device, a tablet computer, or other computing device, as would be understood by those of skill in the art. The computing system 100 comprises a bus 110, a processor 102, a local memory 104, one or more optional input interfaces 114, one or more optional output interfaces 116, a communication interface 112, a storage element interface 106 and one or more storage elements 108. Bus 110 may comprise one or more conductors that permit communication among the components of the computing system. Processor 102 may include any type of conventional processor or microprocessor that interprets and executes programming instructions. Local memory 104 may include a random access memory (RAM) or another type of dynamic storage device that stores information and instructions for execution by processor 102 and/or a read only memory (ROM) or another type of static storage device that stores static information and instructions for use by processor 102. Input interface 114 may comprise one or more conventional mechanisms that permit an operator to input information to the computing device 100, such as a keyboard 120, a mouse 130, a pen, voice recognition and/or biometric mechanisms, etc. Output interface 116 may comprise one or more conventional mechanisms that output information to the operator, such as a display 140, a printer 150, a speaker, etc. Communication interface 112 may comprise any transceiver-like mechanism such as for example two 1 Gb Ethernet interfaces that enables computing system 100 to communicate with other devices and/or systems, for example mechanisms for communicating with one or more other computing systems 200. The communication interface 112 of computing system 100 may be connected to such another computing system by means of a local area network (LAN) or a wide area network (WAN, such as for example the internet, in which case the other computing system 200 may for example comprise a suitable web server. Storage element interface 106 may comprise a storage interface such as for example a Serial Advanced Technology Attachment (SATA) interface or a Small Computer System Interface (SCSI) for connecting bus 110 to one or more storage elements 108, such as one or more local disks, for example 1TB SATA disk drives, and control the reading and writing of data to and/or from these storage elements 108. Although the storage elements 108 above is described as a local disk, in general any other suitable computer-readable media such as a removable magnetic disk, optical storage media such as a CD or DVD disk, solid state drives, flash memory, Random Access Memory (RAM), Read Only Memory (ROM), Electronically Erasable Programmable Read Only Memory (EEPROM) or other memory technologies, holographic media, magnetic cassettes, magnetic tape, magnetic disk storage or other magnetic storage devices that can be used to encode information and can be accessed by the computing system 100 could be used.

The data processing system 1 can be implemented as programming instructions stored it local memory 104 of the computing system 100 for execution by its processor 102. Alternatively the data processing system 1 could be stored on the storage element 108 or be accessible from another computing system 200 through the communication interface 112. Such a plurality of suitably connected computing systems could for example form a system or platform with client-server architecture in which the resource schedules are maintained centrally or distributed on one or more servers.

Although the present invention has been illustrated by reference to specific preferred embodiments, it will be apparent to those skilled in the art that the invention is not limited to the details of the foregoing illustrative preferred embodiments, and that the present invention may be embodied with various changes and modifications without departing from the scope thereof. The present preferred embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and preferred embodiments of the invention are capable of operating according to the present invention in other sequences, or in orientations different from the one(s) described or illustrated above.

1-14. (canceled)

15. A data processing system for resource scheduling taking into account an availability of a set of resources, the data processing system comprising:
a processor configured or programmed to calculate an initial solution space including at least one valid scheduling solution;
a display configured to display the at least one valid scheduling solution when a total solution space is larger than a predetermined total solution space threshold; wherein
the processor is configured or programmed to calculate the total solution space including all valid scheduling solutions; and
the display is configured to display the at least one valid scheduling solution when the total solution space is smaller than the predetermined total solution space threshold.

16. The data processing system according to claim 15, wherein:
the processor is configured or programmed to calculate an additional solution space including at least one additional valid scheduling solution when a number of the valid scheduling solutions is smaller than a predetermined additional solution threshold; and
the display is configured to display the at least one additional valid scheduling solution when the total solution space is larger than the predetermined total solution space threshold.

17. The data processing system according to claim 16, wherein the processor is configured or programmed to calculate the initial solution space and/or the additional solution space as a subset of the total solution space, and the subset of the total solution space is selected as a function of a predetermined set of selection parameters.

18. The data processing system according to claim 17, wherein the predetermined set of selection parameters includes one or more of the following:
a lead time, which is a time period from a present time until an initiation of the at least one valid scheduling solution;
a resource count, which is a number of different resources of the at least one valid scheduling solution;
a schedule duration, which is a time period between the initiation and an end of the at least one valid scheduling solution;
a cost level, which is a function of a cost of the resources of the at least one valid scheduling solution;
a resource priority, which is a preference parameter associated with a specific one of the resources of the at least one valid scheduling solution;
a resource compatibility level, which is a preference parameter associated with a specific combination of the resources of the at least one valid scheduling solution;
a fragmentation level, which is a level of fragmentation in a schedule of the resources of the at least one valid scheduling solution;
a location count, which is a number of different locations associated with the resources of the at least one valid scheduling solution.

19. The data processing system according to claim 17, wherein:
the processor is configured or programmed to calculate for each of the valid scheduling solutions a corresponding quality parameter as a function of the predetermined set of selection parameters; and
the display is configured to display only the at least one additional valid scheduling solution for which the corresponding quality parameter exceeds the corresponding quality parameter of already displayed valid scheduling solutions when the total solution space is larger than the predetermined total solution space threshold.

20. The data processing system according to claim 19, wherein the processor is configured or programmed to calculate the corresponding quality parameter such that a value of the corresponding quality parameter is maximized when the values of the predetermined set of selection parameters are minimized.

21. The data processing system according to claim 20, wherein the processor is configured or programmed to calculate the additional solution threshold as a function of a number of additional valid scheduling solutions that are provided by the additional solution space and which have a corresponding quality parameter that exceeds the corresponding quality parameter of the already displayed valid scheduling solutions.

22. The data processing system according to claim 15, wherein the processor is configured or programmed to calculate the initial solution space by decomposing the resource scheduling into a plurality of Simple Temporal Problems.

23. The data processing system according to claim 22, wherein the processor is configured or programmed to calculate the initial solution space from the plurality of Simple Temporal Problems by operations on Simple Temporal Problem matrices representing the Simple Temporal Problems.

24. The data processing system according to claim 23, wherein the processor is configured or programmed to perform the operations on the Simple Temporal Problem matrices by continuations, the continuations being configured to:
calculate partial results from specific operations on specific Simple Temporal Problem matrices when the partial results of the specific operations are necessary for the calculation of a valid scheduling solution; and
cache the partial results so that the calculation of the specific operations on the specific Simple Temporal Problem matrices has to be performed only once.

25. The data processing system according to claim 15, wherein the processor is configured or programmed to calculate the initial solution space using genetic algorithms.

26. A method of operating a data processing system for resource scheduling taking into account an availability of a set of resources, the method comprising the steps of:
calculating an initial solution space including at least one valid scheduling solution;
displaying the at least one valid scheduling solution when a total solution space is larger than a predetermined total solution space threshold;
calculating the total solution space including all valid scheduling solutions; and
displaying the at least one valid scheduling solution when the total solution space is smaller than the predetermined total solution space threshold.

27. A non-transitory computer readable medium including a computer program including computer code for carrying out, when the computer program is executed on a computer, the method according to claim 26.
